(19) United States
(12) Patent Application Publication
(10) Pub. No.: US 2009/0042098 A1
(43) Pub. Date: Feb. 12, 2009

(54) Storage battery

(76) Inventors: Yasuhide Nakayama, Kyoto-shi (JP); Eiji Hojo, Kyoto-shi (JP); Shuji Takahashi, Wako-shi (JP)

Correspondence Address: BERLINER & ASSOCIATES, 555 WEST FIFTH STREET, 31ST FLOOR, LOS ANGELES, CA, 90013, US

(21) Appl. No.: 12/221,521

(22) Filed: Aug. 4, 2008

(30) Foreign Application Priority Data
Aug. 6, 2007 (JP) 2007-204331

(51) Int. Cl. H01M 2/02

(52) U.S. Cl. 429/179

(57) ABSTRACT

There is provided storage battery that is capable of enabling an easy and speedy fabrication work as well as preventing a terminal thereof from fading or decaying for a long time. A storage battery includes: a lid made of a synthetic resin for closing a container and having cutout portions or recesses; terminals disposed respectively in the cutout portions or the recesses; bushings each having a tubular shape located inside the lid; electrode poles extending from the container for taking out power, the electrode poles respectively inserted into the bushings and welded thereto; conductive portions each for electrically connecting an upper side of the bushing and a lower side of the terminal disposed in parallel with the bushing in a horizontal direction in each of the cutout portions or the recesses; and an auxiliary lid for covering the bushing disposed inside the lid from above. The terminal, the bushing and the conductive portion are monolithically molded to form a terminal portion of the corresponding terminal in each of the cutouts or the recesses. Annular protrusions protrude outwards from a side wall of the conductive portion. At least a lower portion of the bushing and the conductive portion of the terminal portion in each of the cutouts or the recesses are embedded in the lid by insert molding.

### CROSS REFERENCE TO RELATED APPLICATION

This application claims priority from Japanese Patent Application No. 2007-204331, which are incorporated herein by reference.

### BACKGROUND OF THE INVENTION

1. Field of the Invention

The present invention relates to a storage battery suitable for a motorcycle, and more in particular, to a storage battery capable of downsizing by a configuration that a terminal for taking out power does not largely protrude upwards from a lid of a storage battery.

2. Description of the Background Art

A storage battery having a pair of terminals is configured as follows. In each terminal, a bushing having a tubular shape is disposed inside of a lid and an electrode pole protruding upwards from a container is inserted into the bushing to be welded. The terminal is disposed in a cutout portion formed on a front side in a horizontal direction from each bushing. The disposed terminal is connected to the bushing. This configures a vertically compact storage battery without the terminals protruding from the lid. When a storage battery is configured by such configuration as the same size as a conventional, an output thereof becomes larger than the conventional. Thus, this is a recently employed configuration.

A storage battery of such configuration with the terminal has been proposed (for example, refer to JP-A-2003-077454). The bushing is provided inside of the lid made of a synthetic resin. A through-hole is formed in a horizontal plate configuring a portion of an extension extending from one end of the terminal. The horizontal plate is fitted to the bushing via the through hole of the horizontal plate, and they are welded together while being fitted together, thus enabling them to be brought into conductive state. The terminal has an other end provided with a resin-coated member. The resin-coated member is molten by heat and the thus heat molten resin-coated member is fitted into a fitting recess formed on the bottom surface of the cutout portion at a corner of the lid, thereby fixing the terminal to the bottom surface of the cutout portion. Then, a lid plate covering an upper side of the bushing is securely fused by heat sealing to a fitting groove formed on a top of the lid, thereby achieving the attachment of the terminal to the storage battery.

In the storage battery of the structure disclosed in JP-A-2003-077454, it is necessary to weld one end of the terminal to the bushing, and to fuse the resin-coated body provided in the other end of terminal to the fitting recess of the cutout portion of the lid, in addition to welding the electrode pole to the bushing. This causes the fabrication process to be troublesome.

Furthermore, since the extension that connects the bushing to the terminal is exposed to the outside, an electrolyte moving upwards through a small gap between a case and the bushing reaches the terminal through the extension, and thus the terminal may fade or decay.

### SUMMARY OF THE INVENTION

In consideration of the above problems, it is an object of the present invention to provide a storage battery that is capable of enabling an easy and speedy fabrication work as well as preventing a terminal thereof from fading or decaying for a long time.

According to the present invention, there is provided a storage battery that includes: a lid made of a synthetic resin for closing a container and having cutout portions or recesses; terminals disposed respectively in the cutout portions or the recesses; bushings each having a tubular shape located inside the lid; electrode poles extending from the container for taking out power, the electrode poles respectively inserted into the bushings and welded thereto; conductive portions each for electrically connecting an upper side of the bushing and a lower side of the terminal disposed in parallel with the bushing in a horizontal direction in each of the cutout portions or the recesses; and an auxiliary lid for covering the bushing disposed inside the lid from above, in which the terminal, the bushing and the conductive portion are monolithically molded to form a terminal portion of the corresponding terminal in each of the cutouts or the recesses; annular protrusions protrude outwards from a side wall of the conductive portion; at least a lower portion of the bushing and the conductive portion of the terminal portion in each of the cutouts or the recesses are embedded in the lid by insert molding; the bushings each are formed into a taper shape with an inside diameter of a lower side of the bushing being smaller than the inside diameter of an upper side thereof; and the electrode poles each are formed into a taper shape with an external diameter of the lower end of the electrode pole to be connected to a strap being larger than the external diameter of the upper end thereof.

The storage battery may further include an anchor portion formed in the lower end of the terminal, the anchor portion being embedded by a resin used for forming the lid, to generate an anchor effect.

Since each of the terminal portions formed by integrating the terminal, the bushing and the conductive portion together is embedded in the lid by insert molding, it is possible to not only omit the necessity to perform a a fixing work for fixing the terminal to the lid, but also reduce the number of parts or members, thereby providing a storage battery that is capable of enabling an easy and speedy fabrication work. In addition, since the lower portion of the bushing and the conductive portion are tightly embedded in the lid by insert molding, it is possible to prevent an electrolyte from being easily intruded from the storage battery into the lid located above through a gap between the bushing and the lid. Furthermore, even if the electrolyte is intruded into the upper side, a plurality of annular protrusions protruding outwards from the side wall of the conductive portion can prevent the electrolyte from being moved towards the terminal through the gap between the conductive portion and the lid. Thus, it is possible to prevent the terminal from fading or decaying for a long time.

When the anchor portion is formed in the lower end of the terminal and is embedded by a resin used for forming the lid to generate an anchor effect, it is possible to not only increase a contact area with the resin, but also firmly embed the lower end of the terminal. in the resin. Thus, the terminal portions each are unlikely to be separated from the lid.

Since the bushings each are formed into a taper shape with an inside diameter of a lower side of the bushing being smaller than the inside diameter of an upper side thereof, and the electrode poles each are formed into a taper shape with an external diameter of the lower end of the electrode pole being larger than the external diameter of the upper end thereof, a clearance can be provided between the electrode pole and the bushing so that welding can be securely achieved.

### BRIEF DESCRIPTION OF THE DRAWINGS

The above, and other objects, features and advantages of the present invention will become apparent from the detailed description thereof in conjunction with the accompanying drawings wherein.

FIG. 1 is a perspective view showing an upper side of a storage battery;

FIG. 2 is a plan view of the storage battery before attaching an auxiliary lid; and

FIG. 3 is a sectional view of a terminal embedded in a lid attached with the auxiliary lid.

### DETAILED DESCRIPTION OF THE INVENTION

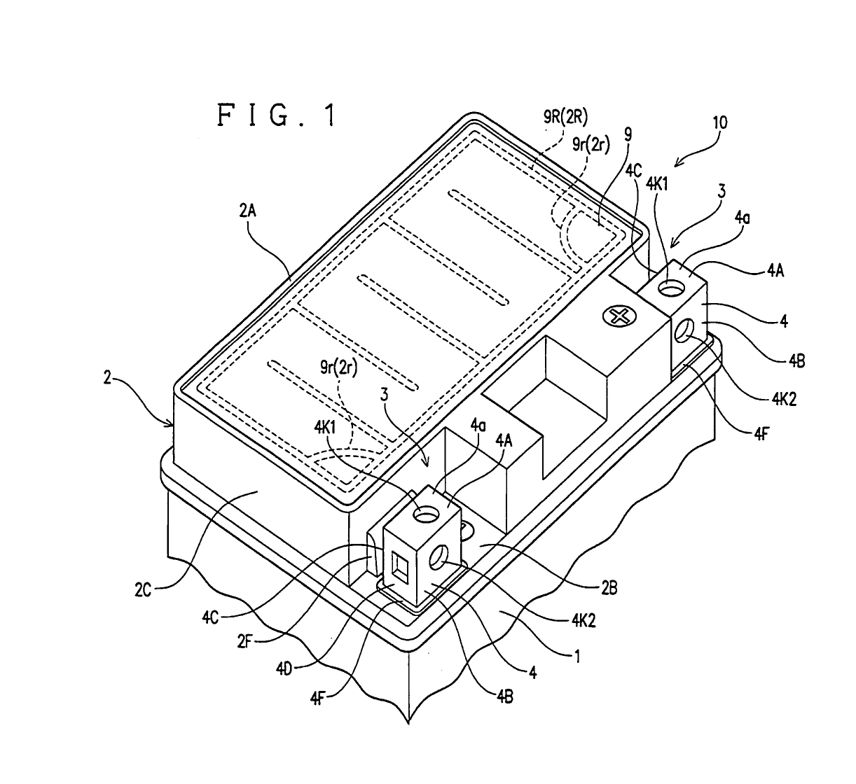

FIG. 1 shows a lead storage battery (hereinafter, simply referred to “storage battery”) especially suitable for a case that the storage battery is mounted on a motorcycle, but can be used for other purposes. This storage battery 10, includes a container 1 having a rectangular shape as seen in plan; a lid 2 made of a synthetic resin and having a rectangular shape as seen in plan for closing and opening of an upper end of the container 1; and an auxiliary lid 9 for closing an opening of an upper end of the lid 2.

Cutout portions 3 are formed respectively at two respective corners, which are oppositely located along either one long side of the lid 2, of four corners of the rectangular lid 2, and terminals 4 and 4 respectively forming a positive polarity and a negative polarity are disposed in the respective cutout portions 3 and 3 (the right terminal is designated as a positive terminal and the left terminal is designated as a negative terminal in this embodiment), thereby preventing upper surfaces 4a and 4a of top plates 4A and 4A of the terminals 4 and 4 from protruding away from an upper end 2A of the lid 2. Although the terminals 4 and 4 are disposed in the cutout portions 3 and 3 formed at the corners of the lid 2 in this case, it is possible to employ an arrangement in which recesses are formed in portions located inwardly away from a peripheral edge of the lid 2 and the terminals 4 and 4 are disposed in the respective recesses.

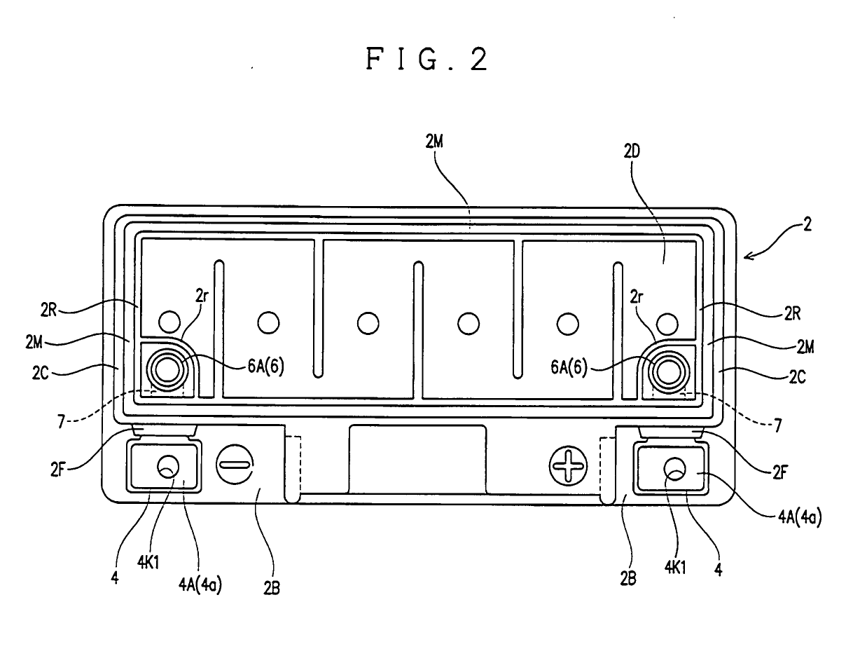

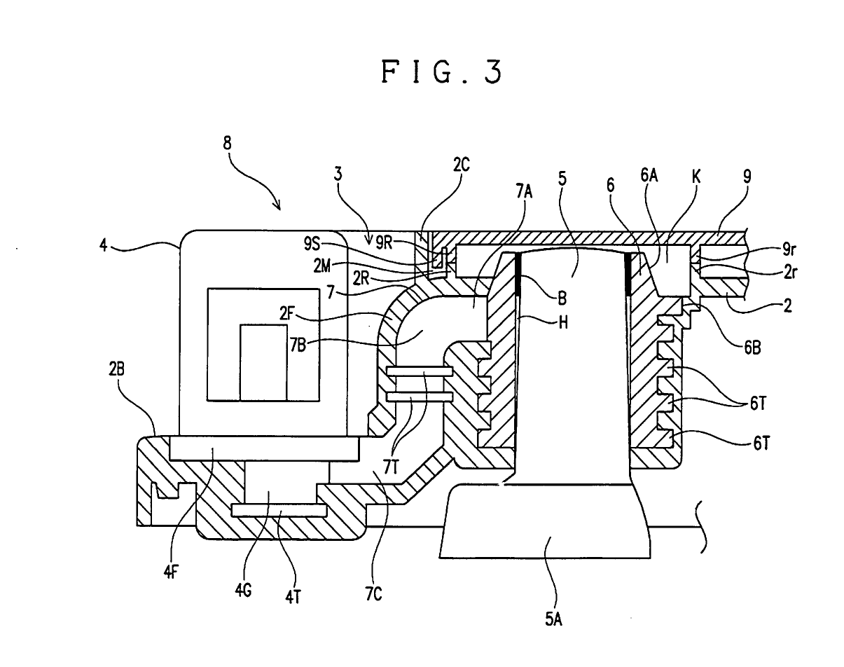

As shown in FIGS. 2 and 3, a tubular bushing 6, into which a electrode pole 5 for taking out power that extends from the container 1 is inserted and welded, is disposed inside of the lid 2. A conductive portion 7 is provided for electrically connecting an upper side of the bushing 6 and a lower side of the terminal 4 disposed in parallel with the bushing 6 in a horizontal direction, and the terminal 4, the bushing 6 and the conductive portion 7 are monolithically molded by lead or lead alloy to form a terminal portion 8. A reference code SA shown in the Figures represents a strap formed monolithically with the electrode pole 5 in a lower end thereof. A portion “B” in black shown in FIG. 3 represents a welding portion where the bushing 6 and the electrode pole 5 is welded by burner-welding, which is superior to a soldering in terms of mechanical strength. The welding portion B before welding has a taper shape provided by having an inside diameter of the lower side of the bushing 6 smaller than that of the upper side thereof and having an external diameter of the lower end of the electrode pole 5 larger than that of the upper end thereof, thereby providing a clearance H. A molten metal is filled in this clearance H and thus welding is achieved.

The rectangular auxiliary lid 9 is provided for covering the bushings 6 disposed inside of the lid 2 from above, that is, for closing the opening of the upper end 2A of the lid 2. The auxiliary lid 9 is laid on the lid 2 after a lower side thereof is molten by heat so as to be fused in position while tightly closing the opening of the lid 2. Giving a detailed description for the lid 2, as shown in FIGS. 1 and 2, a top plate 2D is attached to a vertical plate portion 2C at a height slightly lower than the upper end 2A of the vertical plate portion 2C. The vertical plate portion 2C has a rectangular shape as seen in plan, which rises upwards from the bottom 2B of the lid 2. An annular rib 2R having four corners, two of which respectively have circular arc portions 2r, is arranged in an outer circumference of an upper surface of the top plate 2D almost parallel to the vertical plate portion 2C. With this arrangement, a groove (recess) 2M, into which a skirt 9S formed on the outer circumference of the auxiliary lid 9 is inserted, is provided. A rib 9R having four corners, two of which respectively have circular arcs 9r, is provided on the inner surface (lower surface) of the auxiliary lid 9 corresponding in position to the rib 2R (2r) of the lid 2 to be fused to the rib 2R (2r) for tight closing. The rib 9R has a vertical length shorter than the vertical length of the skirt 9S. With this arrangement, the inner space of the battery surrounded by the ribs 9R(9r) and 2R(2r) can be maintained in a sealed condition. Specifically, the lower side of the rib 9R (9r) of the auxiliary lid is molten by heating and then the skirt 9S of the auxiliary lid 9 is inserted into the groove 2M, while the rib 9R (9r) of the auxiliary lid 9 is pressed to the rib 2R (2r) of the lid 2 so that the ribs 9R (9r) of the auxiliary lid 9 is fused to the rib 2R (2r) of the lid 2.

As shown in FIG. 3, the bushing 6 including the lower portion 6B but excluding the upper portion 6A, and the conductive portion 7 of the terminal portion 8 are embedded in the lid 2 by insert molding. As shown in FIGS. 1 to 3, the vertical plate portion 7B of the conductive portion 7 is covered with outwardly curving portions 2F and 2F outwardly curving away from the vertical plate portion 2C of the lid 2 towards the terminal 4. Thus, as described above, the bushing 6 is insert molded into the lid 2 and a plurality of annular protrusions 6T are formed on a side wall of the bushing 6 aligned in the vertical direction. As shown in FIG. 3, this arrangement prevents an electrolyte of the storage battery 10 from easily intruding into a space K of the upper lid 2 through a gap between the bushing 6 and the lid 2. Even if the electrolyte has intruded into the space K of the upper lid 2 through the gap between the bushing 6 and the lid 2, the arrangement in which the inside surrounded by the ribs 9R (9r) and 2R (2r) is maintained in a sealed condition prevents the electrolyte from leaking onto the surface of the auxiliary lid 9 or to the outside of the storage battery 10.

As shown in FIG. 3, the conductive portion 7 has a first horizontal plate 7A extending in a horizontal direction from the upper side of the bushing 6; the vertical plate portion 7B extending downwards from the end of the first horizontal plate 7A; and a second horizontal plate 7C extending in a horizontal direction from the lower end of the vertical plate portion 7B and being connected to the lower portion of the terminal 4. Two (one or three or more) annular protrusions 7T protruding outwards are disposed around the center of the vertical plate portion 7B at a predetermined interval. Therefore, the protrusions 7T and 7T can more securely block movement of an electrolyte having intruded into the space K of the upper lid 2 to the terminal 4 through the gap between the conductive portion 7 and the outwardly curving portion 2F of the lid 2.

An anchor portion 4T having an oval plate shape is formed monolithically with the lower end of the terminal 4 and is embedded by a resin used for forming the lid. This embedded anchor portion 4T generates an anchor effect. The anchor portion 4T may be separately formed and integrated to the lower end of the terminal 4 by welding or the like. The anchor portion 4T is formed monolithically with a lower end of a connection member 4G extending downwards from a plate-shaped bottom portion 4F which is formed monolithically with the lower end of the terminal 4, and has a larger size than the connection member 4G when seen from a plane.

The terminal 4 includes a rectangular top plate 4A, and a front plate 4B, a rear plate 4C and a left plate 4D which respectively extend perpendicularly downwards from three of the four sides of the top plate 4A excepting the right side when seen from a front side. The top plate 4A and the front plate 4B respectively have through-holes 4K1 and 4K2, through which bolts (not shown) pass. Heads of the bolts (not shown) passing through the through-holes 4K1 and 4K2 are screwed into nuts (not shown) located inside of the terminal 4, and thus the nuts inside the terminal 4 are fixed by the bolts. External lead wires or the like (not shown), which are connectable to an electric sub-assembly etc., are securely held between the bolts and the nuts.

As described above, since the terminal 4 is embedded in the lid 2 at three portions, namely the anchor portion 4T, the conductive portion 7 and the bushing 6, the terminal portion 8 can be firmly integrated with the lid 2, so that the terminal portion 8 is difficult to be separated from the lid 2. As a material of the lid 2 and the auxiliary lid 9, a thermosetting resin such as a polypropylene resin is preferable; however, other synthetic resins may be employed. In addition, when the auxiliary lid 9 is heat molten to the lid 2, these members are preferably made of the same material.

This specification is by no means intended to restrict the present invention to the preferred embodiments set forth therein. Various modifications to the storage battery, as described herein, may be made by those skilled in the art without departing from the spirit and scope of the present invention as defined in the appended claims.

What is claimed is:

1. A storage battery comprising:
a lid made of a synthetic resin for closing a container and having cutout portions or recesses;
terminals disposed respectively in the cutout portions or the recesses;
bushings each having a tubular shape located inside the lid;
electrode poles extending from the container for taking out power, the electrode poles respectively inserted into the bushings and welded thereto;
conductive portions each for electrically connecting an upper side of the bushing and a lower side of the terminal disposed in parallel with the bushing in a horizontal direction in each of the cutout portions or the recesses; and
an auxiliary lid for covering the bushing disposed inside the lid from above,
wherein the terminal, the bushing and the conductive portion are monolithically molded to form a terminal portion of the corresponding terminal in each of the cutouts or the recesses;
annular protrusions protrude outwards from a side wall of the conductive portion;
at least a lower portion of the bushing and the conductive portion of the terminal portion in each of the cutouts or the recesses are embedded in the lid by insert molding;
the bushings each are formed into a taper shape with an inside diameter of a lower side of the bushing being smaller than the inside diameter of an upper side thereof; and
the electrode poles each are formed into a taper shape with an external diameter of the lower end of the electrode pole to be connected to a strap being larger than the external diameter of the upper end thereof.

2. The storage battery according to claim 1, further comprising an anchor portion formed in the lower end of the terminal, the anchor portion being embedded by a resin used for forming the lid, to generate an anchor effect.
